(19) United States
(12) Patent Application Publication
(10) Pub. No.: US 2014/0103659 A1
(43) Pub. Date: Apr. 17, 2014

(54) CONTINUOUS ELECTRICAL GENERATING WATER FLOW SYSTEM /OR C.E.G.F.S.

(71) Applicant: ERNEST PRIOVOLOS, Warrington, PA (US)

(72) Inventor: ERNEST PRIOVOLOS, Warrington, PA (US)

(21) Appl. No.: 13/429,255

(22) Filed: Jun. 26, 2012

(51) Int. Cl. F01D 15/08; F01D 15/10

(52) U.S. Cl. CPC F01D 15/08; F01D 15/10; Y10S 415/916; F03B 17/005
USPC 290/52; 415/916

(57) ABSTRACT

An improved self-contained electrical unit it has three separate components that produces electricity. This by using reducing theory PVC tubing in which increases pressure on the exiting two feet tubes, that spin standard water wheel systems

### CROSS-REFERENCE TO RELATED APPLICATION

Not Applicable

### FEDERALLY SPONSORED RESEARCH OR DEVELOPMENT

Not Applicable

### REFERENCE TO SEQUENCE LISTING, A TABLES OR A COMPUTER LISTING APPENDIX

Not Applicable

### FIELD OF THE INVENTION

The present invention relates to a pulley system which is based on gravity water flow. That refills itself if in the form of land apparatus that self-contained and has three separate components as noted herein.

### DESCRIPTION OF PRIOR ART

The applicant explains the aforementioned patents cited. (TESLA) These are unique and produce DC and AC current which are much like a modern coil, or transformer motor system whether, AC or Dc. However, it is not a complete system and is not attached to any completed form of electrical generation. As noted in this present invention. The following prior art or recently filed applications, involved in hydroelectric generation. These are advances in the impellor and water flow of existing water sources such as, streams or existing water piping in towns. The internal propulsion or pipe generation system noted by the cited applicants only increases energy output of their cited existing Technology. And further one cites using a pump system. Additionally, these are not complete gravity reflow or refill system herein as noted in this present invention.

### SPECIFICATION

The specification of this present invention of a complete land hydro electrical device that produces electrical energy by AC or DC current with a backup battery, to run motor system. It has three separate components and is completely attached by PVC tubing system. The water which is reduced and causes continued thrust, while it goes to the standard water wheel or turbine system. Further the center pulley on the upper shaft, which goes to the lower pulley shaft and turns the two ac high volt generators. Additionally, with the use of standard energy conversion such as, step up coil and the use of battery stored energy, while converting into to dc current or ac current that goes to the local power companies. This is a gravity reflow system that is self-contained and also produce its own energy that enables it to run itself, meaning the battery stored to run the ac or dc motors attached to the upper shaft. This complete unit or electrical device or present invention of scaled drawings. Which uses water conversion flow math and converts into miles per hour of the speed of the two shafts. However the new low speed high volt AC generators would produce enough energy at a speed ratio of four to twenty one miles per hour. Actually, this new noted device would only need seventy two rotations to produce enough continuous self-contained emery noted herein.

### BRIEF DESCRIPTION OF THE DRAWINGS

This present invention is way of example and figures of the accompanying drawings and in which like reference numerals that refer to component's herein.

FIG. 1 The top view of the three component's such as, the water container tube system, the water wheel upper shaft. The reflow and exit container which are attached by water PCV tubing, which makes the unit complete.

FIG. 2 the front view is a V-Shaped water container tubing system that attached to component two which is the water wheel system.

FIG. 3 Is a side view of the water wheel and self-contained water exit component which is attached to the pulley system that is connected to the lower shaft.

FIG. 4 Is the top view of the reflow exit container. And depicts entrance tubes and exit tubes from component that attaches to component one as explain herein.

FIG. 5 Is the top view of the lower pulley system that attaches to the low speed high AC generators and is attached to standard technology such as coil step up system AC and DC energy conversion systems with back up batteries and standard DC energy conversion system.

FIG. 6 Is the side view of a two shape container system, that is sloped at Seven degrees the left container is a container that collects water and flows over the center point and flows into a right side rectangular container for water exiting into component one.

FIG. 7 Top view of the top center pulley system which is the upper shaft that is connected to AC or DC motors and can be used after energy is stored from the reflow system, and thus propel the lower shaft with stored energy.

### SUMMARY OF INVENTION

In order to improve the aforementioned defect, of the above cited applicants. The objective of this present invention is to ensure continuous flow of water and AC generation by using example a ratio of eight to one, on the upper and lower shaft. This upper shaft would turn the lower shaft and by converting RPM's to miles per hour, to propel existing low speed high current output AC generators and use current existing technology to store and convert as noted herein. The various and advantages of the present invention will be more readily understood from the following scaled and detailed drawings.

### DESCRIPTION OF DRAWINGS

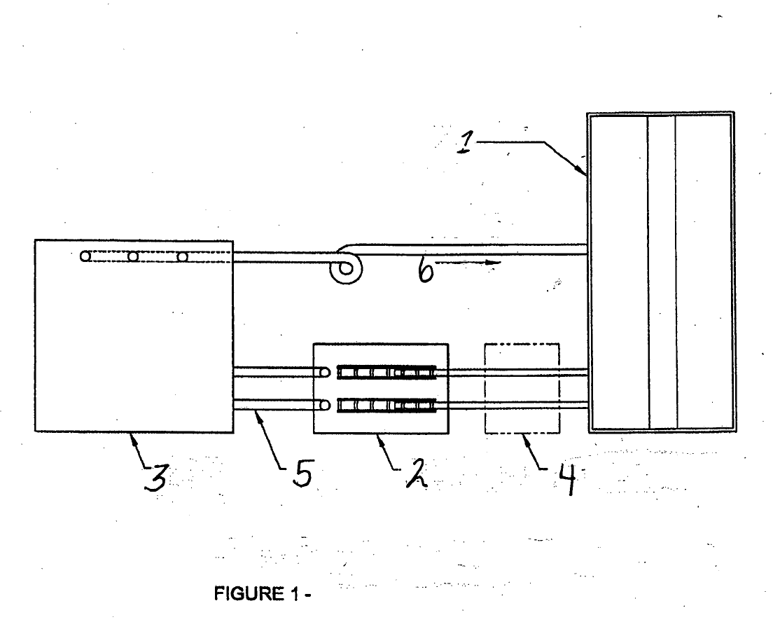

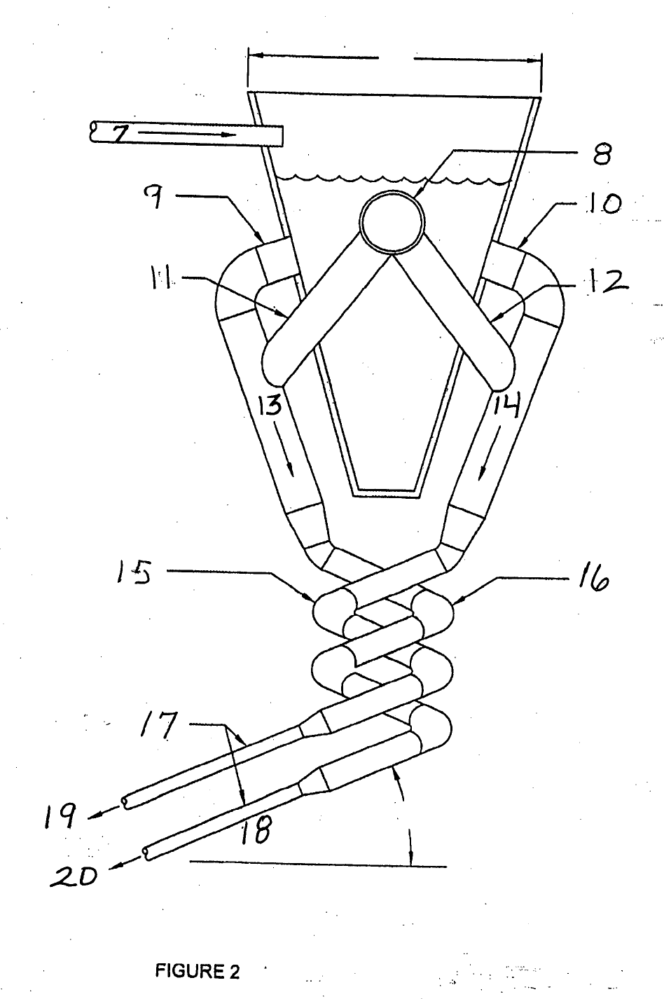

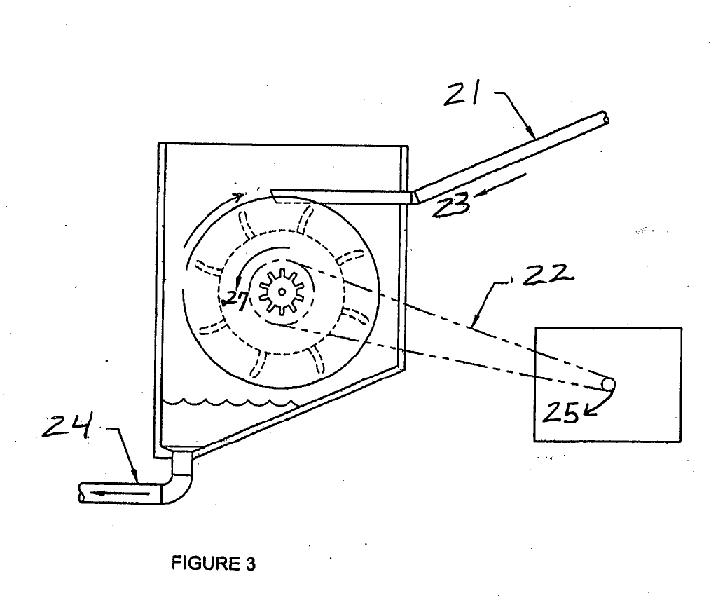

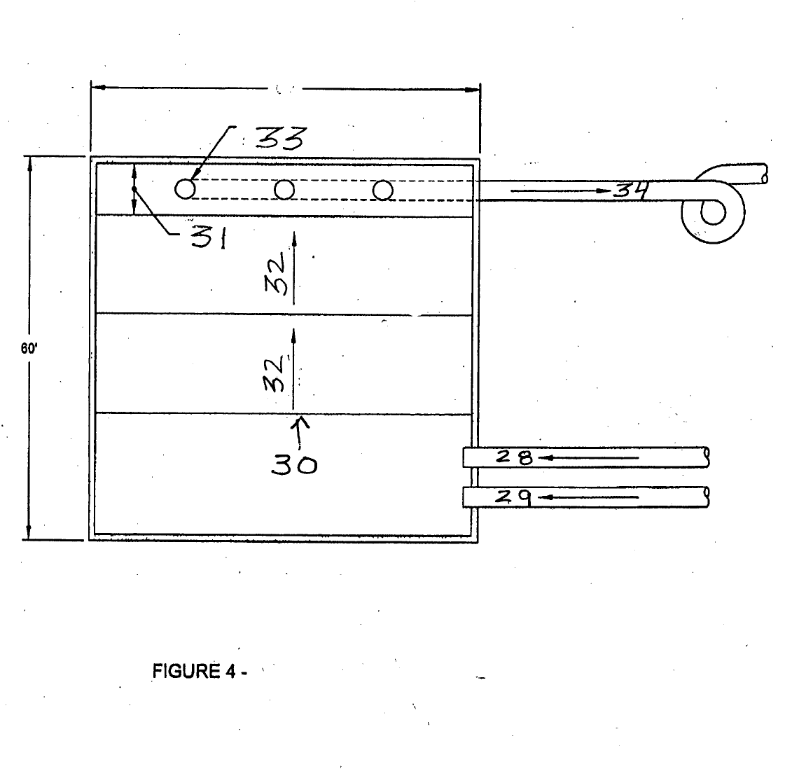

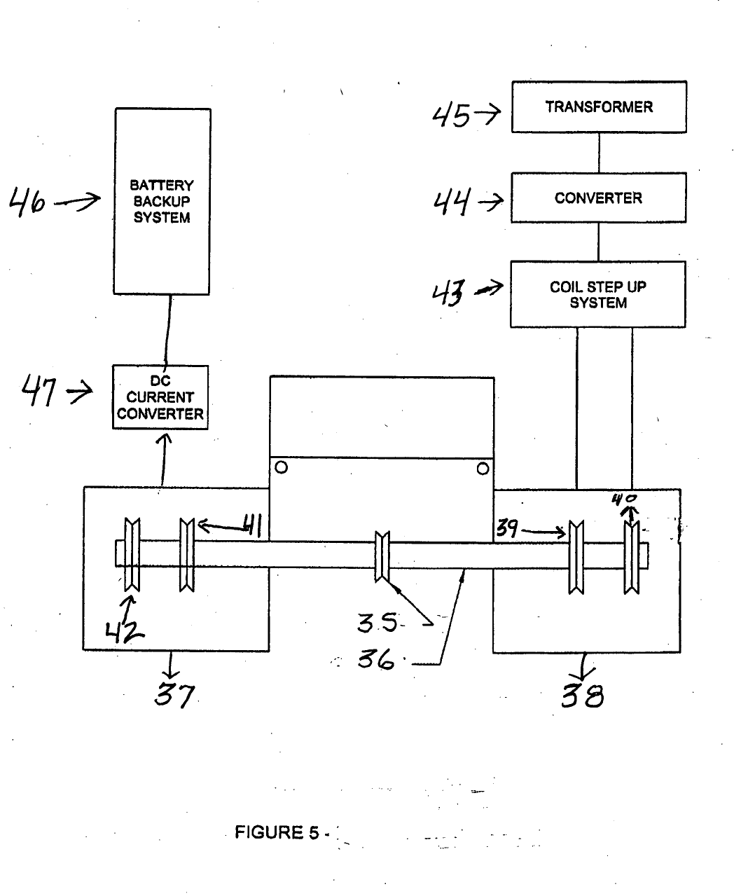

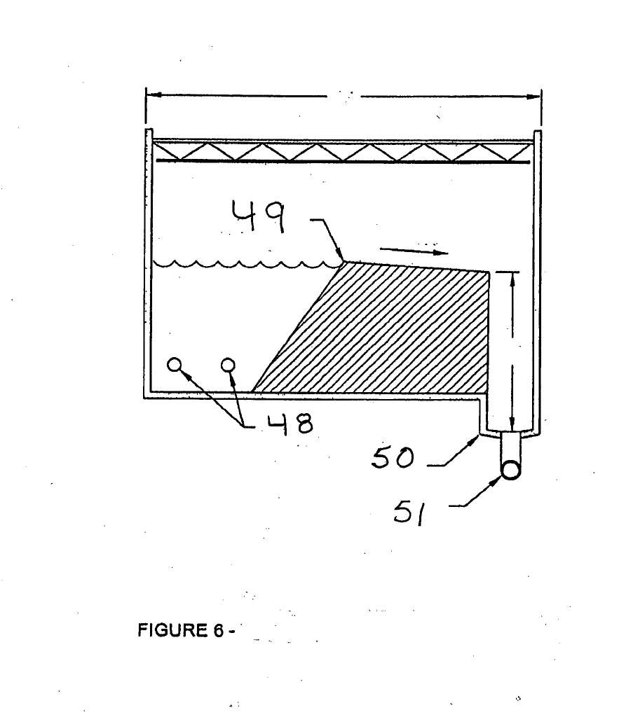

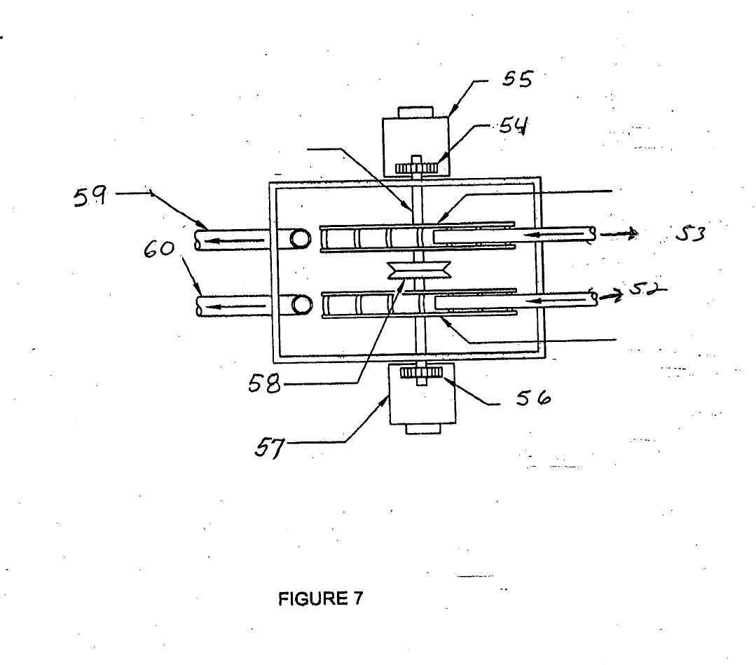

FIG. 1 Illustrates top view starting at number 1 is the water containment building. 2. Is the turbine building 3. Is the exit reflow water building 4. Is the lower shaft energy system building 5. Is the exit water tubes from component two 6. Is the reflow exit slope tubes from component three to component one which is the water trap system, from the center tube as explained. FIG. 2. Illustrates Side view Starting with number 7. Is the flow tube to fill component one the water container. 8. Is the center tube which omits the water collected from the water trap system for container one. 9. Is the left side ten foot tube of component one, that flows water from the other two thirds of the water container component one. 10. Is the right side ten foot tubes as explained. 11. Is the left connecting water trap tube. 12. Is the eight foot right side center trap connecting tube. 13. Is the eight foot left side container tube for the water flow system. 14. Is the right side water flow container tube as explained of component one. 15. Is the left side of the six foot continuous water tube and 16 is the right side of the six foot water flow tube thats connected to component one. 17. Is the top two foot tube and 18 is the lower two foot tube that propels the water turbine at a twenty four degrees angle as shown in FIG. 2. 19. & 20. Is the exit water that propels the water turbine system as shown in FIG. 3. 21. Is the extension part of 19, & 20 Which depicts a side view and 23 is the other tube that goes into the double water turbine as shown in FIG. 7. 24. Is the exit container tube that flows into component three as noted in figure three. 25. Is a side view of the lower pulley system. 26. Is the side view of the water turbine. 27. Is the upper pulley shaft. FIG. 4 Illustrates a top view of the third component as explained starting with number 28.29 Which is the left, and right side of exit tube that is connected to component two and flows into container 30. 30. Is the reflow container that is connected to a seven degree sloped dam like wall which flows into 31 the rectangular reflow tubes that travel into component one as shown on 32,33, and 34. FIG. 5 Illustrates and is a top view and starts with 35 and is the center pulley system for the lower shaft system as explained in 4. 36. Is the lower shaft which connects two the two AC high volt generators as shown in FIG. 5 of numbers 37,38. also 39,40,41,42 are the pulley system that connects to the AC volt generators as shown in FIG. 5. 43. Is the coil step up system that increases the voltage and amps of AC generator number 38. Now 44 is the volt converter panel connected to 45 the voltage transformer that goes directly to the local electrical company for kilowatt consumption as depicted in FIG. 5. 46. Also the battery backup system that is connected to AC Generator number 37. Which is connected to DC currant converter which can be used for electric motors as depicted in FIG. 7.—(55.57) FIG. 6 Illustrates The third component which is the left and right containers Starting with 48 which is a side view of the two entrance tubes inside of the left container of component three which is number 49. As noted in figure four number 32. Is the side view of the seventh degree solid side wall which flows over into rectangular container 50 and is twenty five feet in depth. 51. Is the exit flow tube that is noted in number thirty four and fill up the water trap in component one. FIG. 7 Depicts and is a top view of the pulley upper shaft system starting at 52. Which is the upper water propelling tube and 53 is the other top view of the water propelling tube that turns the two water wheels as shown in FIG. 7. 58. Top view of the upper pulley shaft 59, and 60. Are top views of the exits water tubes that are connected to component as explained herein. 54, and 56 are the upper gear that are connected to motors that propel the upper shaft when battery stored and use to start motors 55. and 57. That independently rotates the upper shaft after component one is shut down.

What is claims:

1. Its another new form, or land Hydroelectric power generation. It has a self-contained water reflow system. The gravity flow and the use of sloping in conjunction with the three components.

2. The component are attached to PVC tubing, and to a V shaped water container at no more than a twenty four degree slope which is at a depth of no more than forty five feet.

3. The standard waterwheel or turbine system has a hollow bottom to retrieve excess water and is connected to PVC exit tubes that follow to the refill container.

4. The exit refill container has a center point in which water overflows into a rectangular container that has a depth of no more than twenty five feet.

5. It has three drain hole connected to ten foot PVC exits drain tubes that are connected to component in which the exit water travels downward into one spiral and further downward until it reaches component one at forty five feet. Then which is a water trap system.

6. The water trap system or the container of component one is blocked or trap by one third of container one.

7. The center tube of component one see figure two Is the water retrieving system from the existing water trap noted above.
